(19) United States
(12) Patent Application Publication
(10) Pub. No.: US 2025/0088011 A1
(43) Pub. Date: Mar. 13, 2025

(54) DUAL POWER/SENSOR PORT WITH DYNAMIC SWITCHING

(71) Applicant: L'Oreal, Paris (FR)

(72) Inventors: Rafael FELICIANO, New Providence, NJ (US); Casey BARBARINO, San Anselmo, CA (US)

(73) Assignee: L'Oreal, Paris (FR)

(21) Appl. No.: 18/462,604

(22) Filed: Sep. 7, 2023

(51) Int. Cl. H02J 7/00

(52) U.S. Cl. CPC H02J 7/00034; H02J 7/00041; H02J 7/0047; H02J 7/0068; H02J 7/00714

(57) ABSTRACT

A system, including a device including a first connector, a processor, and a power source, and at least one accessory including a second connector, where the at least one accessory configured to be coupled to the device. When the device and the at least one accessory are coupled, the first connecter contacts the second connector, where the first connector and the second connector is rotationally symmetrical, such that the second connector is configured to couple with the first connector in a plurality of orientations. When the first connector couple with the second connector, the processor is configured to sense a charge level of the at least one accessory, and when the charge level is below a predetermined charge threshold, switch between sensing the charge level of the at least one accessory to charging the at least one accessory with the power source.

### SUMMARY

In one aspect, disclosed herein is a system, including a device with a first connector, a processor, and a power source, and at least one accessory including a second connector, where the at least one accessory is configured to be coupled to the device, where, when the device and the at least one accessory are coupled, the first connecter contacts the second connector, where the first connector and the second connector are rotationally symmetrical, such that the second connector is configured to couple with the first connector in a plurality of orientations. In some embodiments, during operation when the first connector couples with the second connector, the processor is configured to sense a charge level of the at least one accessory, and when the charge level is below a predetermined charge threshold, switch between sensing the charge level of the at least one accessory to charging the at least one accessory with the power source.

In some embodiments, the first connector comprises a first plurality of contacts, and the second connector comprises a second plurality of contacts. In some embodiments, the number of contacts in the first plurality of contacts is equal to the number of contacts in the second plurality of contacts. In some embodiments, the first plurality of contacts includes a first central contact and two first ancillary contacts, and the second plurality of contacts includes a second central contact and two second ancillary contacts. In some embodiments, the first central contact is configured to couple with the second central contact, and either of the first ancillary contacts is configured to couple with either of the second ancillary contacts.

In some embodiments, the device further includes a current sensor configured to monitor a current of the at least one accessory, and a sensing unit configured to sense the charge of the at least one accessory. In some embodiments, during operation the processor is receives a signal indicative of a monitored current level from the current sensor and switches off the power source, and enables the sensing unit, when the monitored current level is below a current threshold. In some embodiments, the current threshold condition is indicative of a no power draw as measured by the current sensor. In some embodiments, the first central contact and the second central contact are configured to toggle switch between a charging line and a communication line based on the measured charge level.

In some embodiments, the at least one accessory includes a battery, and a power line monitor, and when the first connector contacts the second connector, the processor is further configured to receive a charge level sensed by the power line monitor, and when the charge level is below the predetermined charge threshold, switch between communicating with the at least one accessory to charging the battery of the at least one accessory. In some embodiments, the device includes a first switching circuit and a first 1-wire bus, and the processor is further configured to, when the charge level is below the predetermined charge threshold, switch off the power source, and enable the first 1-wire bus. In some embodiments, the at least one accessory further comprises a second switching circuit and a second 1-wire bus, and an accessory processor, where the accessory processor is configured to receive a charge level from the power line monitor, when the charge level is below a predetermined charge threshold, transmit the charge level to the first processor, when the charge level is above the predetermined threshold, toggle to the second 1-wire bus, and communicate with first processor to stop charging the battery.

In another aspect, disclosed herein is a method of switching between charging and communicating with an accessory, the method including connecting a first connector of a device to a second connector of the accessor, where the first connector has a first plurality of contacts, the second connector has a second plurality of contacts. In some embodiments, a number of contacts in the first plurality of contacts is equal to a number of contacts in the second plurality of contacts, and the second connector is configured to couple to the second connector in a first plurality of orientations, sensing a charge level of the at least one accessory, when the charge level is below a predetermined threshold, and switching between sensing the charge level of the at least one accessory to charging the at least one accessory with a power source of the device.

In some embodiments, the first connector comprises a first plurality of contacts, and the second connector comprises a second plurality of contacts. In some embodiments, a number of contacts in the first plurality of contacts is equal to a number of contacts in the second plurality of contacts. In some embodiments, the first plurality of contacts includes a first central contact, and two first ancillary contacts, and wherein the second plurality of contacts includes a second central contact and two second ancillary contacts. In some embodiments, the first central contact is configured to interact with the second central contact, and either of the first ancillary contact. is configured to interact with either of the second ancillary contacts.

In some embodiments, the method further includes receiving a monitored current from a current sensor of the at least one accessory, when the monitored current is below a current threshold, switching off the power source, and enabling a sensing unit of the device, wherein the sensing unit is configured to sense the charge level of the at least one accessory.

In some embodiments, the at least one accessory further comprises a battery and an accessory processor, and wherein the method further includes transmitting a request for charging from the accessory processor to the device processor, transmitting the charge level from the accessory processor to the device processor, when the charge level is above a second threshold, transmitting a request for no charging to the processor, switching off the power source, and enabling a communication line between the device and the at least one accessory with the device processor. In some embodiments, where the communication line between the device and the at least one accessory is facilitated with a first 1-wire bus on the device and a second 1-wire bus on the at least one accessory.

In some embodiments, the device includes a first switching circuit, the accessory comprises a second switching circuit, and switching from sensing the charge level of the at least one accessory to charging the at least one accessory includes transmitting a request for charging to the device processor, when the charge level is above the predetermined threshold switching from transmitting the request for charging to transmitting a request for no charging with the accessory switching circuit, when the request for no charging is received by the device processor, switching off the power source, and enabling a communication line between the device and the at least one accessory with the device processor with the second switching circuit.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is an example system, in accordance with the present technology;

FIG. 1B is an example system, in accordance with the present technology;

FIG. 1C is a front-side perspective view of an example device of the example system of FIG. 1B, in accordance with the present technology;

FIG. 1D is a back-side perspective view of the example device of the example system of FIG. 1B, in accordance with the present technology;

FIG. 1E is a front-side perspective view of an example accessory of the example system of FIG. 1B, in accordance with the present technology;

FIG. 1F is a back-side perspective view of the example accessory of the example system of FIG. 1B, in accordance with the present technology;

FIG. 2A is an example system, in accordance with the present technology;

FIGS. 2B-2E show the example system of FIG. 2A in various orientations, in accordance with the present technology;

FIG. 3 is an example circuit diagram of a system, in accordance with the present technology;

FIG. 4 is another example circuit diagram of a system, in accordance with the present technology;

FIG. 5 is an example method, in accordance with the present technology;

FIG. 6 is another example method, in accordance with the present technology; and

FIG. 7 is another example method, in accordance with the present technology.

### DETAILED DESCRIPTION

Disclosed herein is a system and associated methods for switching between sensing and charging an accessory with a device. In some embodiments, the accessory and the device each include a connector (i.e., a first connector on the device and a second connector on the accessory). In some embodiments, the first connector and the second connector are configured to couple the device and the accessory. In some embodiments, the first connector and the second connector are rotationally symmetrical, that is, the accessory and/or the device may be oriented in various orientations and still couple with the first connector and the second connector. In operation, when the first connector and the second connector are physically coupled (or contacted), the device may switch between sensing a charge level of the accessory, and, when the charge level falls to or below a predetermined threshold, charging the accessory.

In some embodiments, the accessory is at least one accessory of a plurality of accessories. In some embodiments, a device may be packaged and/or sold with a plurality of accessories, each having a rotationally symmetrical second connector. In this manner, the device may switch between sensing and charging each accessory of the plurality of accessories, as desired by a user of the system. For example, the device may be a handle of a hair care device, such as a curling iron or hairbrush, and each accessory of the plurality of accessories could be a different powered curling wand or brush head.

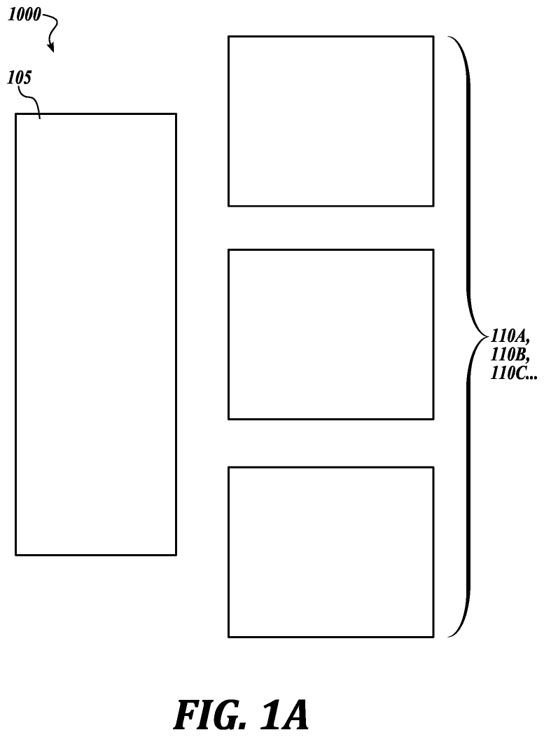

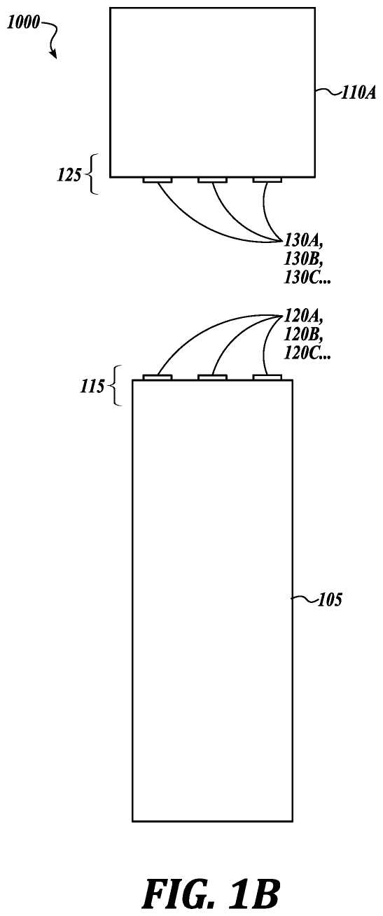

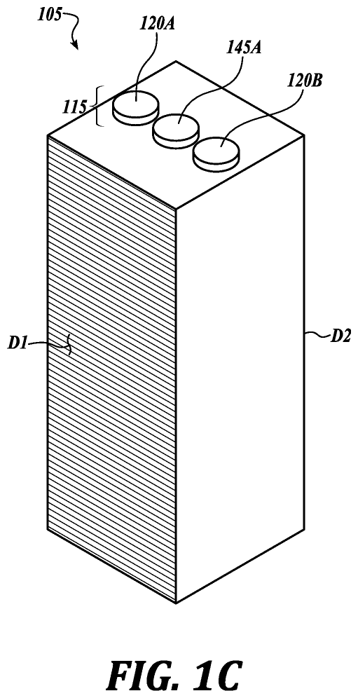

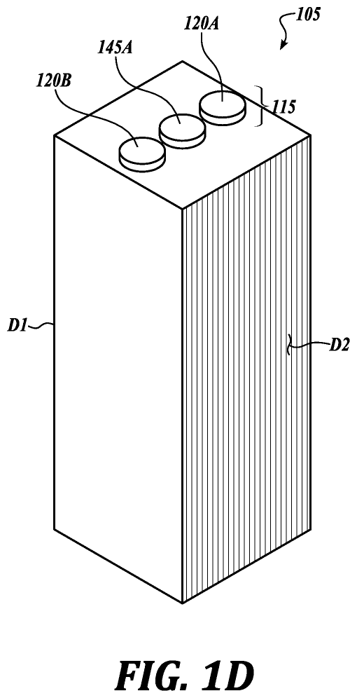

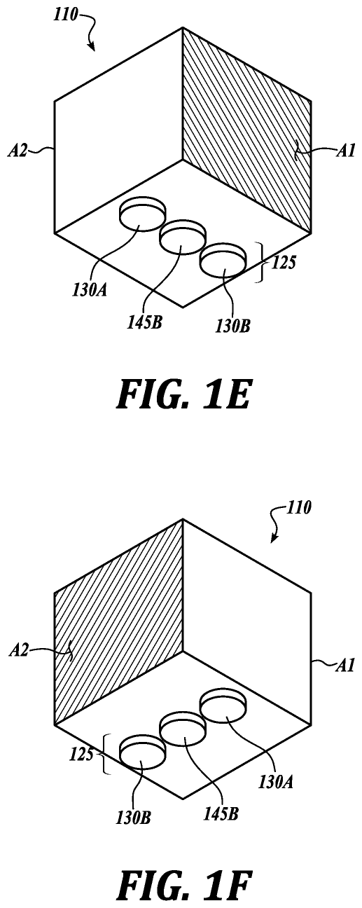

FIG. 1A is an example system 1000, in accordance with the present technology. In one aspect, disclosed herein is a system 1000, including a device 105 and a plurality of accessories 110A, 110B, 110C. In some embodiments, there may be three accessories in the plurality of accessories, but one skilled in the art should recognize there may be any number of accessories in the plurality of accessories, including a single accessory. In some embodiments, at least one accessory 110A of the plurality of accessories 110A, 110B, 110C is configured to be coupled to the device 105. In some embodiments, the device 105 is configured to be coupled with any accessory 110A 110B, 110C, of the plurality of accessories 110A, 110B, 110C.

In operation, when the device 105 is coupled to the at least one accessory 110A, the device 105 is configured to sense a charge level of the at least one accessory 110A. When the charge level is below a predetermined charge threshold, the device 105 switches between sensing the charge level of the at least one accessory 110 Ato charging the at least one accessory 110A.

FIG. 1B is an example system 1000, in accordance with the present technology. In some embodiments, the device 105 includes a first connector 115. In some embodiments, the at least one accessory 110A (also referred to herein as “the accessory”) includes a second connector 125. In some embodiments, the first connector 115 comprises a first plurality of contacts 120A, 120B, 120C, and the second connector 125 comprises a second plurality of contacts 130A, 130B, 130C. In some embodiments, a number of contacts in the first plurality of contacts 120A, 120B, 120C is equal to a number of contacts in the second plurality of contacts 130A, 130B, 130C. For example, in some embodiments, the number of contacts in the first plurality of contacts 120A, 120B, 120C is three and the number of contacts in the second plurality of contacts 130A, 130B, 130C is three. In some embodiments, the first plurality of contacts 120A, 120B, 120C is configured to align with and interact with the second plurality of contacts 130A, 130B, 130C. In some embodiments, the first plurality of contacts 120A, 120B, 120C, the second plurality of contacts 130A, 130B, 130C, or both, are pins, copper pads, physical connectors, or some combination thereof.

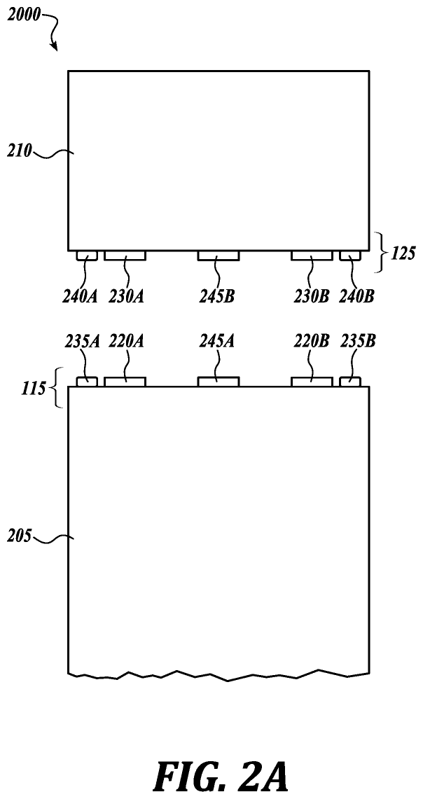

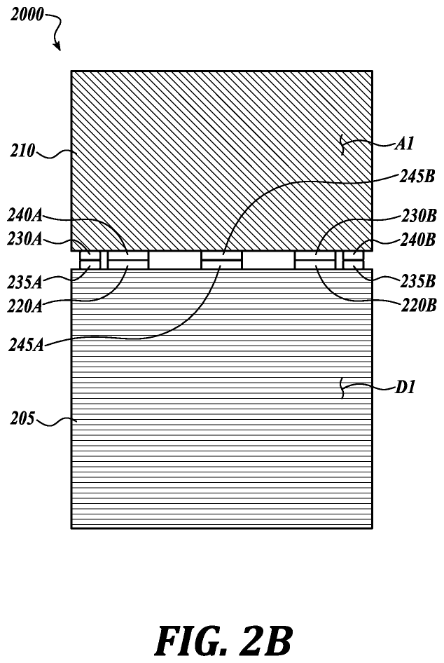

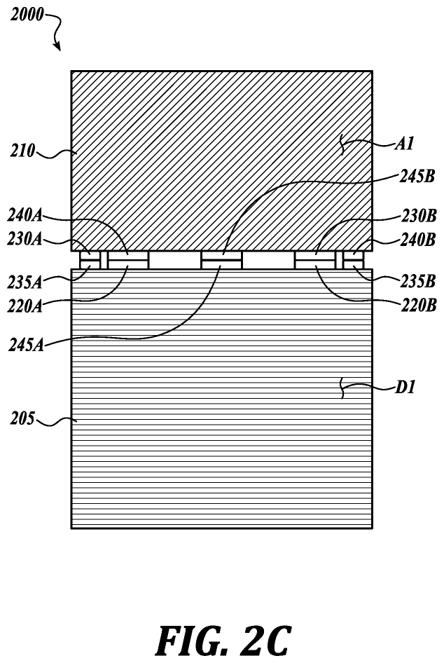

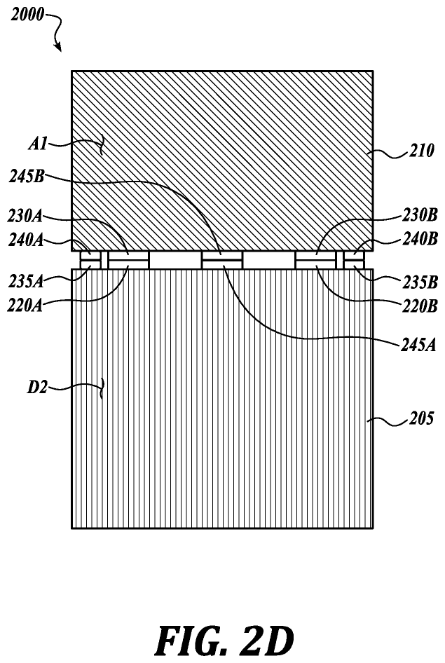

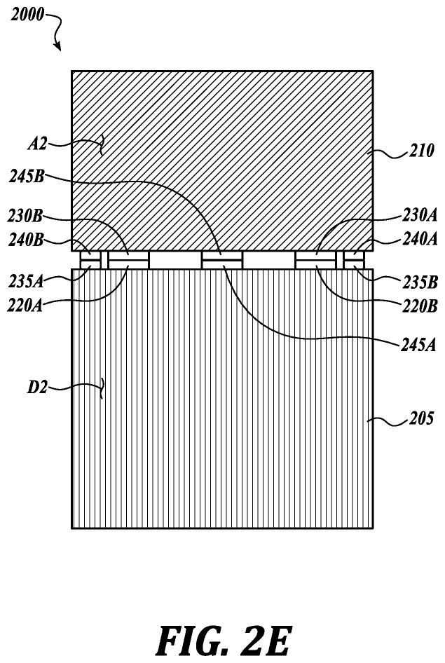

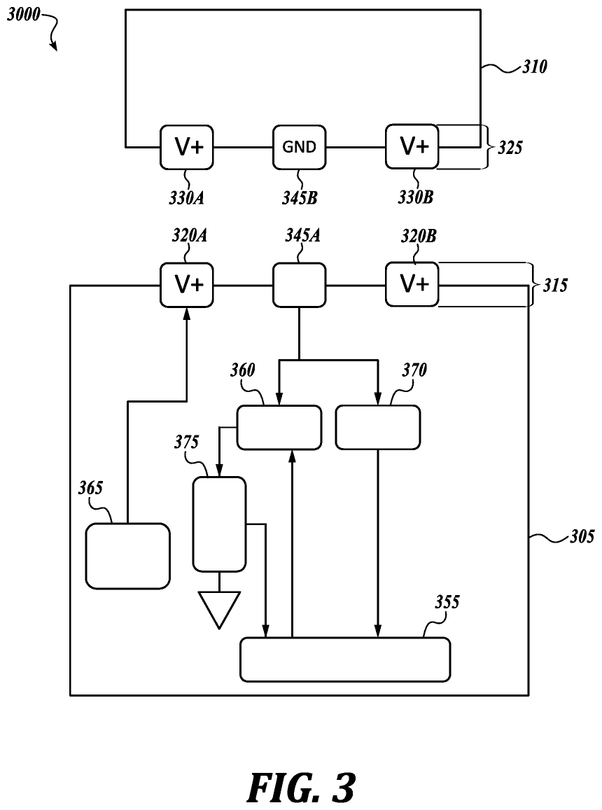

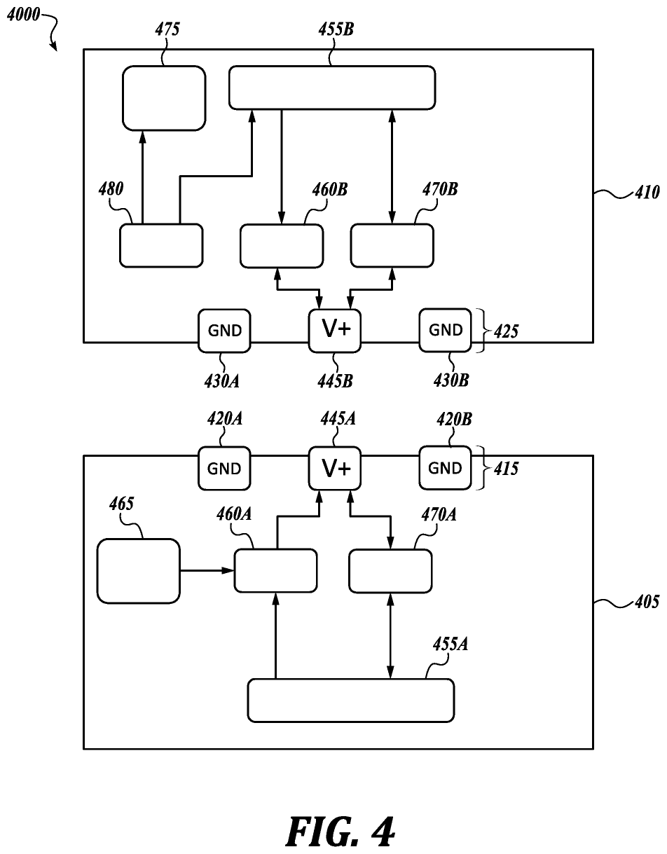

In operation, the at least one accessory 110A may be coupled with the device 105 in a plurality of orientations, as shown in FIGS. 2B-2E. In some embodiments, when the device 105 and the at least one accessory 110A are coupled, the device 105 senses a charge level of the accessory 110A, and when the charge level is below a predetermined charge threshold, charges the at least one accessory 110A, as shown and described in detail in FIGS. 3 and 4.

FIG. 1C is a front-side D1 perspective view of an example device 105 of the example system 1000 of FIG. 1B, in accordance with the present technology. FIG. 1D is a back-side D2 perspective view of the example device 105 of the example system 1000 of FIG. 1B, in accordance with the present technology.

In some embodiments, the first plurality of contacts 120A, 120B, 145A includes a first central contact 145A and two first ancillary contacts 120A, 120B. In some embodiments, the first connector 115 is rotationally symmetrical, such that the first connector 115 is configured to couple with a second connector of an accessory (such as accessory 110) in a plurality of orientations, as shown and described in detail in FIGS. 2B-2E. In some embodiments, the device 105 includes at least a first side (or front side) D1 and a second side (or back side) D2. In some embodiments, the first connector 115 is rotationally symmetrical such that the first connector 115 is symmetrical on the first side D1 and the second side D2 (that is, rotationally symmetrical at a 180-degree rotation about the first central contact 145A). In some embodiments, the first connector 115 is rotationally symmetrical about the first central contact 145A. In some embodiments, such as when the first plurality of contacts 120A, 120B, 145A is greater than three, the first connector 115 may be rotationally symmetrical from more than just the first side D1 and the second side D2. In such embodiments, the first connector 115 may be configured to couple with an accessory at any rotational orientation (such as a 90-degree rotation, a 15-degree rotation or the like about the first central contact 145A). Accordingly, both the first connector and the second connector may have a 2-fold, 3-fold, 4-fold, 5-fold, 6-fold, or n-fold rotational symmetry.

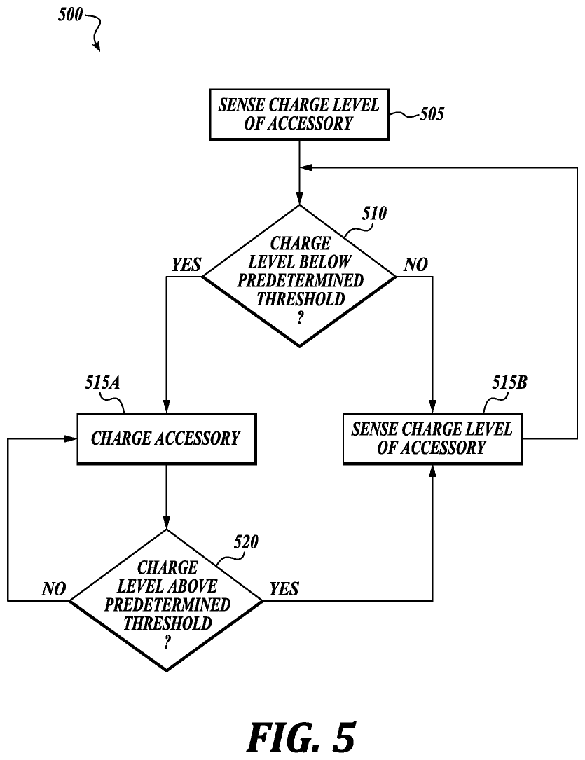

In some embodiments, the first central contact 145A is configured to establish a communication link and/or charging link between the device 105 and an accessory (such as accessory 110). In some embodiments, the first central contact 145A may be a ground, as shown in FIG. 5.

In some embodiments, the first ancillary contacts 120A, 120B are configured to deliver power to two second ancillary contacts of an accessory (such as shown in FIGS. 1E-1F). In some embodiments, the two first ancillary contacts 120A, 120B are positive terminals, as shown in FIG. 3. In some embodiments, the two first ancillary contacts 120A and 120B are configured to deliver power from a power supply of the device 105 to the accessory, as shown in FIG. 3. In some embodiments, the two first ancillary contacts 120A, 120B are grounds, as shown in FIG. 4.

FIG. 1E is a front-side A1 perspective view of an example accessory 110 of the example system 1000 of FIG. 1B, in accordance with the present technology. FIG. 1F is a back-side A2 perspective view of the example accessory 110 of the example system 1000 of FIG. 1B, in accordance with the present technology.

In some embodiments, the second plurality of contacts 130A, 130B, 145B includes a second central contact 145B and two second ancillary contacts 130A, 130B. In some embodiments, the second connector 125 is rotationally symmetrical, such that the second connector 125 is configured to couple with a first connector of a device (such as device 105) in a plurality of orientations, as shown and described in detail in FIGS. 2B-2E. In some embodiments, the accessory includes at least a first side (or front side) A1 and a second side (or back side) A2. In some embodiments, the second connector 125 is rotationally symmetrical such that the second connector 125 is symmetrical on the first side A1 and the second side A2 (that is, rotationally symmetrical at a 180-degree rotation about the second central contact 145B). In some embodiments, the second connector 125 is rotationally symmetrical about the second central contact 145B. In some embodiments, such as when the second plurality of contacts 130A, 130B, 145B is greater than three, the second connector 125 may be rotationally symmetrical from more than just the first side A1 and the second side A2. In such embodiments, the second connector 125 may be configured to couple with a device at any rotational orientation (such as a 90-degree rotation, a 15-degree rotation, or the like about the second central contact 145B).

In some embodiments, the second central contact 145B is configured to establish a communication link between the device 105 and an accessory (such as accessory 110). In some embodiments, the second central contact 145B is a ground.

In some embodiments, the two second ancillary contacts 130A, 130B are configured to receive power to two first ancillary contacts of a device (such as shown in FIGS. 1E-1F). In some embodiments, the two second ancillary contacts 130A, 130B are positive terminals, as shown in FIG. 3. In some embodiments, the two second ancillary contacts 130A, 130B are configured to receive power from two first ancillary contacts of a device to the accessory 110 or a battery of the accessory as shown in FIGS. 3-4. In some embodiments, the two second ancillary contacts 130A and 130B are grounds, as shown in FIG. 4.

FIG. 2A is an example system 2000, in accordance with the present technology. In some embodiments, the system 2000 includes a device 205 and an accessory 210. In some embodiments, the device 105 includes a first central contact 245A, two first ancillary contacts 220A, 220B, and two first attachments 235A, 235B. In some embodiments, the accessory 210 includes a second central contact 245B, two second ancillary contacts 230A, 230B, and two second attachments 240A, 240B.

In some embodiments, the first central contact 145A is configured to couple with the second central contact 145B, and either first ancillary contact 120A, 120B is configured to couple with either second ancillary contact 130A, 130B, as shown in FIGS. 2B-2E.

In some embodiments, the first attachments 235A, 235B and/or the second attachments 240A, 240B may be magnets, clasps, snaps, pins, connectors having a male or female component, a combination thereof, or the like. In some embodiments, the first attachments 235A, 235B are rotationally symmetrical about the first central contact 245A, and the second attachments 240A, 240B are rotationally symmetrical about the second central contact 245B, such that the first attachments 235A, 235B and the second attachments 240A, 240B may couple in any number of orientations, as shown in FIGS. 2B-2E.

In operation, when the device 105 and the at least one accessory 110A, 110B, 110C are coupled, the first connecter 115 contacts the second connector 125. In some embodiments, the first attachments 235A, 235B and the second attachments 240A, 240B are configured to couple in various orientations, as shown in FIGS. 2B-2E.

FIGS. 2B-2E show the example system of FIG. 2A, with the accessory and the device coupled in a plurality of orientations, in accordance with the present technology. In some embodiments, the device 205 and the accessory 210 may couple with the first connector 115 and the second connector 125 in a plurality of orientations, such as with a front side A1 of the accessory in a same plane as a front side of the device D1 (FIG. 2B), a back side A2 of the accessory in a same plane as a front side of the device D1 (FIG. 2C), a front side A1 of the accessory in a same plane as a back side of the device D2 (FIG. 2C), and a back side A2 of the accessory in a same plane as a back side of the device D2 (FIG. 2E).

One skilled in the art should understand that depending on the design of the device 105, the accessory 110, the first connector 115, and the second connector 125, any number of sides and/or orientations may be possible. For example, in an embodiment where the first connector 115 and the second connector 125 include a first central contact 145A, and a plurality of first ancillary contacts 120A, 120B arranged in a first ring, and a second central contact 1245B, and a plurality of second ancillary contacts 130A, 130B arranged in a second ring, the device 105 and accessory 110 could each be rotated, independently or in tandem, while still allowing the first connector 115A and the second connector 115B to be coupled. Further, one skilled in the art should understand that the device 105 and/or the accessory 110 may have any number of sides, and these sides may be flat, curved, rounded, beveled, labeled, organically shaped, geometrically shaped, and/or include one or more planes. In some embodiments, the first side D1 of the device and the second side D2 of the device are distinct from one another in color, shape, size, or the like. Similarly, in some embodiments, the first side A1 of the accessory and the second side A2 of the accessory are distinct from one another in color, shape, size, or the like. In some embodiments, the first side D1 of the device is substantially the same as the second side D1 of the device, and/or the first side A1 of the accessory is substantially the same as the second side A2 of the accessory.

FIG. 3 is an example circuit diagram of a system 3000, in accordance with the present technology. One skilled in the art should understand the circuit diagram may be incorporated into system 1000 or 2000 as described and shown herein. Further, the system 3000 may be incorporated in any orientation shown in FIGS. 2B-2E or otherwise described herein.

In some embodiments, the system 3000 includes a device 305 and an accessory 310. In some embodiments, the accessory 310 includes a second connector 325. In some embodiments, the second connector 325 includes a plurality of contacts 330A, 330B, 345B. In some embodiments, the plurality of contacts 330A, 330B, 345B includes a second central contact 345B and two second ancillary contacts 330A, 330B.

In some embodiments, the device 305 includes a first connector 315. In some embodiments, the first connector 315 includes a plurality of contacts 320A, 320B, 345A. In some embodiments, the plurality of contacts includes a first central contact 345A and two first ancillary contacts 320A, 320B. In some embodiments, the device 305 includes a processor 355, a switching circuit 360, a power source 365, a sensing circuit (or sensing unit) 370, and a current sensor 375.

In some embodiments, the first ancillary contacts 320A, 320B and the second ancillary contacts 330A, 330B are positive terminals, indicated as “V+” in FIG. 3. In some embodiments, the two first ancillary contacts 120A and 120B are configured to deliver power from a power supply 365 of the device 105 to the accessory 110. In some embodiments, the second central contact 345B is a ground (GND).

In some embodiments, the first central contact 345A is communicatively and/or physically coupled with the switching circuit 360 and the sensing circuit 370. In some embodiments, the switching circuit 360 is a relay circuit, a metal-oxide-semiconductor field-effect transistor (MOSFET), or the like. In some embodiments, the switching circuit 360 is communicatively and/or physically coupled to the current sensor 375.

In operation, when the first connector 315 is coupled to the second connector 325, the first central contact 345A and the second central contact 345B are communicatively and/or physically connected. In some embodiments, the two first ancillary contacts 320A, 320B communicatively and/or physically connect with the two second ancillary contacts 330A, 330B. In some embodiments, the first connector 315 and the second connector 325 are rotationally reciprocal. Accordingly, in some embodiments, either first ancillary contact 320A, 320B may communicatively and/or physically connect with either second ancillary contact 330A, 330B, such as shown in FIGS. 2B-2E. In some embodiments, the first central contact 345A and the second central contact 345B are configured to switch between a charging line (that is, to facilitate charging of the accessory 310) and a communication line (that is, to facilitate sensing of the charge level (or charge level detection state) of the accessory 310) based on the measured charge level.

When the first connector 315 and the second connector 325 couple, the sensing unit 370 senses a charge level of the accessory 310. In some embodiments, when the charge level is below a predetermined threshold (also referred to as a predetermined first charge threshold herein), the switching circuit 360 switches to charging the accessory by enabling the power source 365. In some embodiments, the power source 365 charges the accessory through a connection between one first ancillary pin 220A, 220B and one second ancillary pin 230A, 230B. In some embodiments, the predetermined threshold is when the charge level is at or about 0, that is, when the accessory 310 is “dead” or otherwise unable to operate. In some embodiments, the predetermined threshold is at or about a percentage of a total charge level of the accessory, such as 5%, 10%, or 15%.

In some embodiments, the current sensor 375 is configured to monitor a power draw of the at least one accessory 310. In some embodiments, when the charge level is at or below the predetermined threshold, the power source 365 is enabled, and the current sensor 375 then senses the power draw. When the power draw is at or below a current threshold, the switching circuit 360 switches from the power source 365 to the sensing unit 370. In some embodiments, the current threshold is met when no (or zero) power draw is measured by the current sensor 375.

FIG. 4 is another example circuit diagram of a system 4000, in accordance with the present technology. One skilled in the art should understand the circuit diagram may be incorporated into system 1000 or 2000 as described and shown herein. Further, the system 4000 may be incorporated in any orientation shown in FIGS. 2B-2E or otherwise described herein.

In some embodiments, the device 405 includes a device processor (or first processor) 455A, a first switching circuit 460, a power source 465, and a first 1-wire bus 470A. In some embodiments, the accessory 410 includes a battery 475, a power line monitor 480, a second switching circuit 460B, and a second 1-wire bus 470B.

One skilled in the art should understand that as described herein, the first 1-wire bus 470A and the second 1-wire bus 470B may be principal/agent busses that communicate via a single signal wire and a ground (such as first central contact 145A and second central contact 145B, respectively). The device and/or accessory may communicate on the first 1-wire bus 470A and second 1-wire bus 470B respectively by pulling a signal to ground and by sampling a logic level of the signal line.

In operation, when the first connector 415 is coupled to the second connector 425, the first central contact 445A and the second central contact 445B are communicatively and/or physically connected. In some embodiments, the two first ancillary contacts 420A, 420B communicatively and/or physically connect with the two second ancillary contacts 430A, 430B. In some embodiments, the first connector 415 and the second connector 425 are rotationally reciprocal. Accordingly, in some embodiments, either first ancillary contact 420A, 420B may communicatively and/or physically connect with either second ancillary contact 430A, 430B, such as shown in FIGS. 2B-2E. In some embodiments, the first central contact 445A and the second central contact 445B are configured to switch between a charging line (that is, to facilitate charging of the accessory 410) and a communication line (that is, to facilitate sensing of the charge level of the accessory 410) based on the measured charge level.

In some embodiments, the first ancillary contacts 420A, 420B and the second ancillary contacts 430A, 430B are grounds, indicated as “GND” In FIG. 4. In some embodiments, the first central contract 445A and the second central contact 445B are positive terminals, “V+”.

In operation, when the first connector 415 couples with the second connector 425, the device processor 455A receives a charge level sensed by the power line monitor 480, and when the charge level is below the predetermined charge threshold, the device 405 switches between communicating with the at least one accessory 410 to charging the battery 475 of the at least one accessory 410. In some embodiments, the device processor 455A is further configured to, when the charge level is below the predetermined charge threshold, switch off (or switch from) the power source 465, and enable the first 1-wire bus 470A. In some embodiments, the accessory processor 455B is configured to receive a charge level from the power line monitor 480, and when the charge level is below a predetermined charge threshold, transmit the charge level to the device processor 455A. In some embodiments, when the charge level is above the predetermined threshold, the second switching circuit 460B toggles to the second 1-wire bus 470B and communicates with device processor 455A to stop charging the battery 475.

In some embodiments, the accessory processor 455B is configured to transmit a request for charging to the device processor 455A. In some embodiments, when the charge level is above or at a second threshold a request for no charging is transmitted from the accessory processor 455B to the device processor 455A. In some embodiments, the request for no charging is the absence of a request for charging.

FIG. 5 is an example method 500, in accordance with the present technology. In some embodiments, the method 500 may be carried out with system 1000, 2000, 3000, and/or 4000 as disclosed herein. In some embodiments, the system includes a device (such as device 105, 205, 305, 405) and an accessory (such as accessory 110, 210, 310, 410). In some embodiments, the device includes a first connector (such as first connector 115, 215, 315, 415) and the accessory has a second connector (such as second connector 125, 225, 325, 425). In some embodiments, the first connector and/or the second connector are rotationally symmetrical, such that the device and the accessory may be coupled in a plurality of orientations, as shown in FIGS. 2B-2E.

In block 505, a charge level of the accessory is sensed. In some embodiments, the charge level is sensed with a sensing unit, such as sensing unit 370, in FIG. 3. In some embodiments, the sensing unit 370 is communicatively coupled to a first central contact (such as first central contact 145A, 245A, 345A, 445A) and/or a device processor (such as processor 355).

In decision block 510, it is determined if the charge level of the accessory is below a predetermined threshold. In some embodiments, the predetermined threshold is when the charge level of the accessory is at or about zero. In some embodiments, the predetermined threshold is below a charge level, such as below about 5%, 10%, or 15% charge. If the charge is below the predetermined threshold, the method proceeds to block 515A.

In block 515A, the accessory is charged. In some embodiments, the accessory is charged by switching from the sensing unit to a power source (such as power source 365) with a switching circuit (such as switching circuit 360). In some embodiments, the switching circuit enables the power source to begin charging the accessory. In some embodiments, the power source is communicatively coupled to one of two first ancillary contacts (such as two first ancillary contacts 120A, 120B, 220A, 220B, 320A, 320B, 420A, 420B).

In decision block 520, after charging the accessory, it is determined whether the charge level is above the predetermined threshold. In some embodiments, the charge level is sensed after a predetermined time of charging. If the charge level is not above the predetermined threshold, the method returns to block 515A. If the charge level is above the predetermined threshold, the method proceeds to block 515B.

In block 515B, the charge level of the accessory is sensed. In some embodiments, the switching circuit switches from the current sensor to the sensing unit.

Returning to block 510, if the charge level is not below the predetermined threshold, the method proceeds to block 515B.

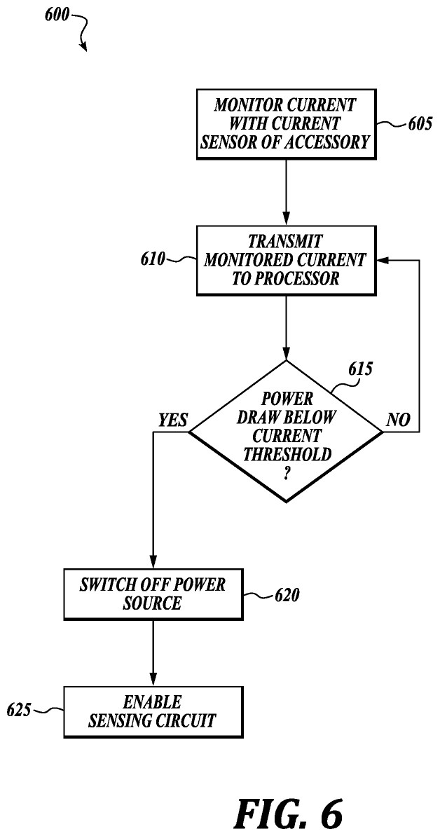

FIG. 6 is another example method 600, in accordance with the present technology. In some embodiments, the method 500 may be carried out with system 1000, 2000, 3000, and/or 4000 as disclosed herein. In some embodiments, the method includes a device (such as device 105, 205, 305, 405) and an accessory (such as accessory 110, 210, 310, 410). In some embodiments, the device includes a first connector (such as first connector 115, 215, 315, 415) and the accessory has a second connector (such as second connector 125, 225, 325, 425). In some embodiments, the first connector and/or the second connector are rotationally symmetrical, such that the device and the accessory may be coupled in a plurality of orientations, as shown in FIGS. 2B-2E.

In block 610, a monitored current from a current sensor (such as current sensor 375) is received from the at least one accessory. In some embodiments, the current sensor is communicatively coupled to a switching circuit (such as switching circuit 360). In some embodiments, the switching circuit switches between a sensing unit and the switching circuit.

In block 610, the monitored current is transmitted to a processor (such as device processor 365).

In decision block 615, it is determined whether a power draw is at or below a current threshold. In some embodiments, the current threshold is when the current sensor no longer senses a power draw. In some embodiments, this occurs when the accessory is fully charged, i.e., when a charge level of the accessory is at 100%. In some embodiments, the charge level is detected or sensed after a predetermined amount time passes, such as 15 minutes, 30 minutes, or an hour. When the power draw is above the current threshold, the method returns to block 610. When the power draw is at or below the current threshold, the method proceeds to block 620.

In block 620, the power source is switched off. In some embodiments, a switching circuit switches from the power source to the sensing circuit.

In block 625, the sensing circuit is enabled.

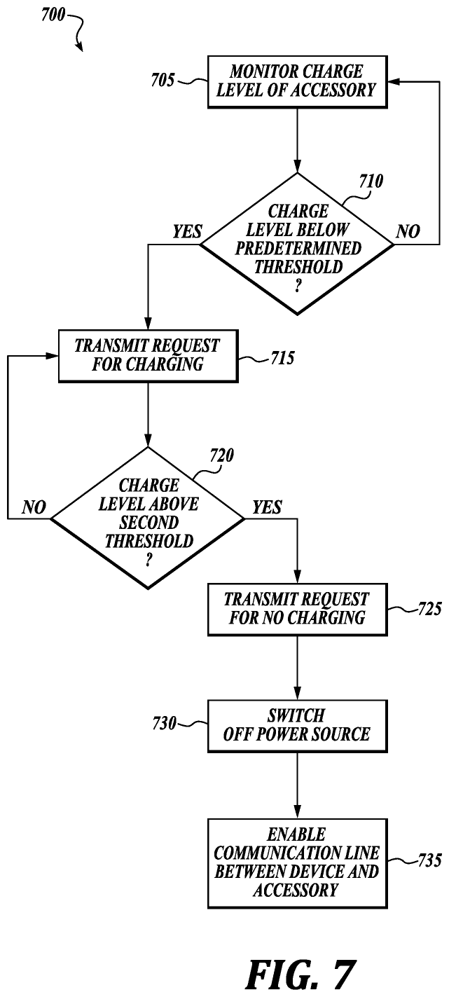

FIG. 7 is another example method 700, in accordance with the present technology. In some embodiments, the method includes a device (such as device 105, 205, 305, 405) and an accessory (such as accessory 110, 210, 310, 410). In some embodiments, the device includes a first connector (such as first connector 115, 215, 315, 415) and the accessory has a second connector (such as second connector 125, 225, 325, 425). In some embodiments, the first connector and/or the second connector are rotationally symmetrical, such that the device and the accessory may be coupled in a plurality of orientations, as shown in FIGS. 2B-2E.

In decision block 720, it is determined whether a charge level is at or below a predetermined threshold. In some embodiments, the predetermined threshold is when the charge level of the accessory is at or about zero. In some embodiments, the predetermined threshold is below a charge level, such as below about 5%, 10%, or 15% charge. If the charge level is above the predetermined threshold, the method returns to block 705. If the charge is below the predetermined threshold, the method proceeds to block 715.

In block 715, a request for charging is transmitted. In some embodiments, the request for charging is transmitted from an accessory processor (such as accessory processor 355B) to a device processor (such as device processor 355A).

In decision block 720, it is determined whether a charge level is above or at a second threshold. In some embodiments, when the charge level is not above the second threshold, the method returns to block 715. If the charge level is above the second threshold the method proceeds to block 725.

In block 725, a request for no charging is transmitted. In some embodiments, the request for no charging is just the request for charging not being transmitted. In some embodiments, the request for no charging is transmitted from the accessory processor to the device processor.

In block 730, a power source (such as power source 365) is switched off. In some embodiments, a switching circuit (such as switching circuit 360A) switches from the power source to the sensing circuit.

In block 735, a communication line between the device and the accessory is enabled. In some embodiments, the communication line is established between the first central contact (such as first central contact 345A, 445A) and the second central contact (such as second central contact 345B, 445B).

It should be understood that all methods 500, 600, and 700 should be interpreted as merely representative. In some embodiments, process blocks of all methods 500, 600, and 700 may be performed simultaneously, sequentially, in a different order, or even omitted, without departing from the scope of this disclosure.

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

What is claimed is:

1. A system, comprising:
a device including a first connector rotationally symmetrical to a second connector of an accessory, the second connector configured to couple electrically and physically with the first connector in a plurality of orientations; and
a processor configured to:
enable a charge level detection state when the first connector and the accessory are electrically and physically coupled;
determine a charge level of the accessory;
when the charge level is below a predetermined first charge threshold level, switch to a charging state configured to charge the accessory by electrically coupling the accessory to a power source; and
switch back to the charge level detection state when the charge level meets or exceeds the predetermined first charge threshold level.

2. The system of claim 1, wherein a first plurality of contacts of the first connector has a 2-fold, 3-fold, 4-fold, 5-fold, 6-fold, or n-fold rotational symmetry with a corresponding second plurality of contacts of the second connector.

3. The system of claim 2, wherein a number of contacts in the first plurality of contacts is equal to a number of contacts in the second plurality of contacts.

4. The system of claim 3, wherein:
the first plurality of contacts includes a first central contact and two first ancillary contacts, and
wherein the second plurality of contacts includes a second central contact and two second ancillary contacts.

5. The system of claim 4, wherein:
the first central contact is configured to couple with the second central contact, and
either first ancillary contact is configured to couple with either of the second ancillary contacts.

6. The system of claim 1, wherein the device further includes:
a current sensor configured to monitor a current of the at least one accessory; and
a sensing unit configured to sense the charge of the at least one accessory,
wherein the processor is further configured to:
receive the monitored current from the current sensor;
when the monitored current is below a current threshold,
switch off the power source; and
enable the sensing unit.

7. The system of claim 6, wherein the current threshold is when no power draw is measured by the current sensor.

8. The system of claim 1, wherein the first central contact and the second central contact switch between a charging line and a communication line based on the measured charge level.

9. The system of claim 1, wherein the at least one accessory further includes a battery and a power line monitor, and
wherein when the first connector contacts the second connector, the processor is further configured to:
receive a charge level sensed by the power line monitor; and
when the charge level is below the predetermined first charge threshold,
switch between communicating with the at least one accessory to charging the battery of the at least one accessory.

10. The system of claim 9, wherein the device further comprises a first switching circuit and a first 1-wire bus, and wherein the processor is further configured to:
when the charge level is below the predetermined first charge threshold, switch off the power source; and
enable the first 1-wire bus.

11. The system of claim 10, wherein the at least one accessory further comprises a second switching circuit and a second 1-wire bus, and an accessory processor, wherein the accessory processor is configured to:
receive a charge level from the power line monitor;
when the charge level is below the predetermined first charge threshold, transmit the charge level to the first processor; and
when the charge level is above a predetermined second charge threshold, toggle to the second 1-wire bus, and
communicate with first processor to stop charging the battery.

12. A method of switching between charging and communicating with an accessory, the method comprising:
connecting a first connector of a device to a second connector of the accessory, wherein the first connector has a first plurality of contacts, the second connector has a second plurality of contacts, a number of contacts in the first plurality of contacts is equal to a number of contacts in the second plurality of contacts, and the second connector is configured to couple to the second connector in a plurality of orientations;
sensing a charge level of the at least one accessory; and
when the charge level is below a predetermined first charge threshold;
switching between sensing the charge level of the accessory to charging the accessory with a power source of the device.

13. The method of claim 12, wherein:
the first connector comprises a first plurality of contacts, and
the second connector comprises a second plurality of contacts,

14. The method of claim 13, wherein a number of contacts in the first plurality of contacts is equal to a number of contacts in the second plurality of contacts.

15. The method of claim 14, wherein the first plurality of contacts includes a first central contact, and two first ancillary contacts, and wherein the second plurality of contacts includes a second central contact and two second ancillary contacts.

16. The method of claim 15, wherein the first central contact is configured to interact with the second central contact, and either first ancillary contact is configured to interact with either second ancillary contact.

17. The method of claim 12, wherein the method further comprises:
receiving a monitored current from a current sensor of the accessory;
when the monitored current is below a current threshold, switching off the power source; and
enabling a sensing unit of the device, wherein the sensing unit is configured to sense the charge level of the accessory.

18. The method of claim 17, wherein the accessory further comprises a battery and an accessory processor, and wherein the method further comprises:
transmitting a request for charging from the accessory processor to the device processor;
transmitting the charge level from the accessory processor to the device processor;
when the charge level is above a predetermined second charge threshold, transmitting a request for no charging to the processor;
switching off the power source; and
enabling a communication line between the device and the accessory with the device processor.

19. The method of claim 18, wherein the communication line between the device and the accessory is facilitated with a first 1-wire bus on the device and a second 1-wire bus on the at least one accessory.

20. The method of claim 19, wherein the device includes a first switching circuit, the accessory comprises a second switching circuit, and switching from sensing the charge level of the accessory to charging the accessory comprises:
transmitting a request for charging to the device processor;
when the charge level is above the predetermined first charge threshold switching from transmitting the request for charging to transmitting a request for no charging with the accessory switching circuit; and
when the request for no charging is received by the device processor, switching off the power source; and
enabling a communication line between the device and the accessory with the device processor with the second switching circuit.
